(19) United States
(12) Patent Application Publication
(10) Pub. No.: US 2009/0262693 A1
(43) Pub. Date: Oct. 22, 2009

(54) METHOD AND APPARATUS FOR BROADCAST OF SYSTEM INFORMATION TRANSMISSION WINDOW

(75) Inventors: Peter S. Wang, East Setauket, NY (US); Shankar Somasundaram, Deer Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/423,403

(22) Filed: Apr. 14, 2009

Related U.S. Application Data
(60) Provisional application No. 61/046,337, filed on Apr. 18, 2008.

(51) Int. Cl. H04W 72/00

(52) U.S. Cl. 370/329

(57) ABSTRACT

A method and an apparatus are provided for allocating sub-frames in a system information transmission window, allocating transmission sub-frames consecutively at the beginning of the system information transmission window, allocating non-transmission sub-frames at end of the system information transmission window, and transmitting the system information transmission window. A method and apparatus for receiving and ordering of system information messages is also provided.

### CROSS REFERENCE TO RELATED APPLICATIONS

This application claims the benefit of a U.S. Provisional Application Ser. No. 61/046,337 filed on Apr. 18, 2008, which is incorporated by reference as if fully set forth.

### FIELD OF INVENTION

This application relates to wireless communications.

### BACKGROUND

A current goal of the third generation partnership project (3GPP) long term evolution (LTE) program is to provide new technology, new architecture, and new methods using new LTE settings and configurations. This provides improved spectral efficiency, reduced latency, and better utilization of radio resources to provide faster user experiences and richer applications and services with less cost.

System information is carried in a radio resource control (RRC) layer message. One of the functions of RRC is to broadcast the system information. System information messages (SIs) are LTE RRC messages that carry one or more system information blocks (SIBs). All of the SIBs included in an SI have the same scheduling requirement (i.e., periodicity); each SIB contains a set of related system information parameters. The system information is broadcast by the network and acquired by a terminal. The system information thus includes information about downlink and uplink cell bandwidths, the uplink or downlink channel configurations, detailed parameters related to random-access transmission, uplink power control, and other information as per the SIB or SIBs contained in a particular system information message. There are many SIs in the LTE system that may be sent from a evolved universal mobile telecommunications system terrestrial radio access (E-UTRA) cell.

FIG. 1 shows a conventional system information acquisition procedure 100 between a wireless transmit receive unit (WTRU) 110 and an enhanced universal terrestrial radio access network (E-UTRAN) (also referred to as enhanced Node B (eNB)) 120. One of the SIBs defined is a master information block (MIB) 125, which includes a limited number of most frequently transmitted parameters. Another SIB defined is a system information block Type 1 (SIB-1) 128, which contains the scheduling information that indicates when the other SIs 130 are transmitted (i.e., start times). The MIB 125 is transmitted using a broadcast channel (BCH) while the other SIBs (contained in SIs) and the SIB-1 are carried on a downlink shared channel (DL-SCH).

The WTRU 110 provides the system information acquisition procedure 100 to acquire access stratum (AS) and non-access-stratum (NAS) system information that is broadcast by the eNB 120. The procedure 100 applies to a WTRU 110 in RRC idle (RRC_IDLE) state and to a WTRU 110 in RRC connected (RRC_CONNECTED) state.

In LTE, each SIB and therefore each system information is responsible for carrying a different category of information related to a specific functionality of a WTRU, such as channel configuration, cell reselection measurement configuration, etc. As a result, SIB sizes and aggregations in system information may vary. The SIB sizes are carried by a pure number of LTE sub-frames (i.e., X). Also, a system assigned transmission windows for all SIs are of the same length in number of LTE sub-frames (i.e., Y). Thus, X out of Y sub-frames are used for a SI, transmission within the SIₙ transmission window, where, X≦Y. The SIₙ transmission on X will be referred to as transmit (Tx) sub-frames, hereafter.

The new LTE system information broadcast employs a system information transmission window design of equal length or equal size. Therefore, a method and an apparatus are desired for handling system information broadcast transmission windows that provides mechanisms and parameters specifying the system information transmission windows, their Tx sub-frame allocation and the related signaling details. Also, signaling for associating or synchronizing the eNB 120 transmissions and the WTRU 110 receptions of the LTE system information broadcast transmission windows are desired.

### SUMMARY

A method and an apparatus are provided for allocating sub-frames in a system information transmission window, allocating transmission sub-frames consecutively at the beginning of the system information transmission window, allocating non-transmission sub-frames at end of the system information transmission window, and transmitting the system information transmission window. A method and apparatus for receiving and ordering of system information messages is also provided.

### BRIEF DESCRIPTION OF THE DRAWINGS

A more detailed understanding may be had from the following description, given by way of example in conjunction with the accompanying drawings wherein:

FIG. 1 shows a conventional system information acquisition procedure between the WTRU and the eNB;

FIG. 2 shows an example wireless communication system including a plurality of WTRUs and an eNB in accordance with one embodiment;

FIG. 3 is a functional block diagram of a WTRU and the eNB of the wireless communication system shown in FIG. 2;

FIGS. 4A and 4B show allocation of the Tx sub-frames within a single window, at the beginning and at the end of the Tx-window, respectively;

FIGS. 6A and 5B show arrangements of even and odd number of system information transmission windows, respectively;

FIG. 6A shows a system information transmission window with an offset to the packed transmit sub-frames;

FIG. 6B shows a system information transmission window using a bit-map for system information transmit sub-frames; and

FIG. 7 shows an exemplary flow diagram for receiving and ordering the system information in a staggering situation.

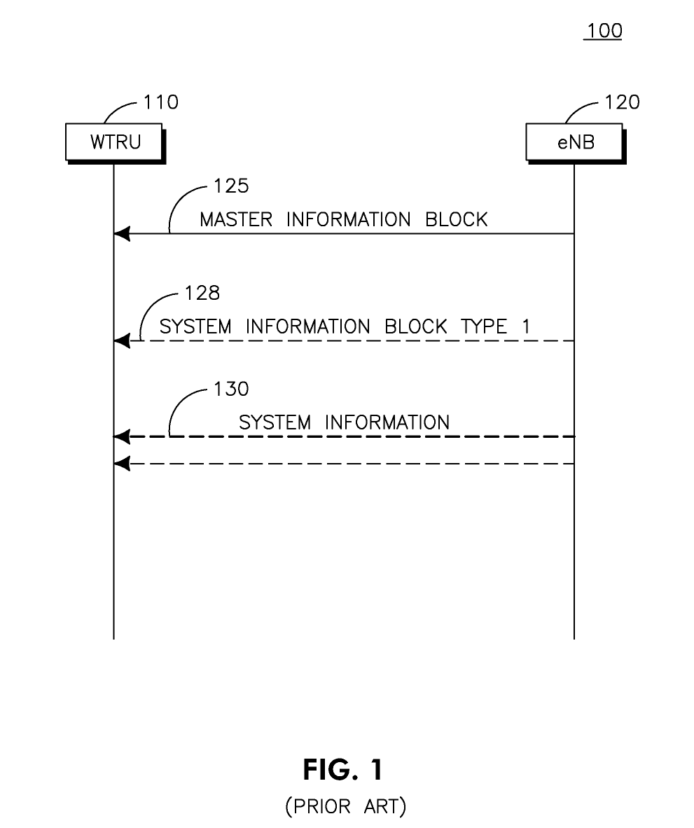

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

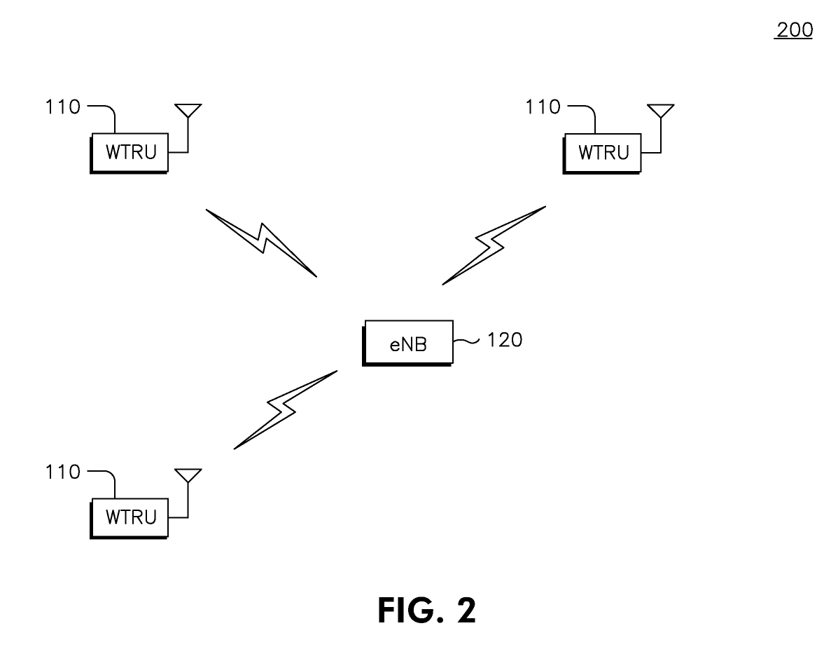

FIG. 2 shows a wireless communication system 200 including a plurality of WTRUs 110 and an eNB 120. As shown in FIG. 2, the WTRUs 110 are in communication with the eNB 120. Although three WTRUs 110 and one eNB 120 are shown in FIG. 2, it should be noted that any combination of wireless and wired devices may be included in the wireless communication system 200.

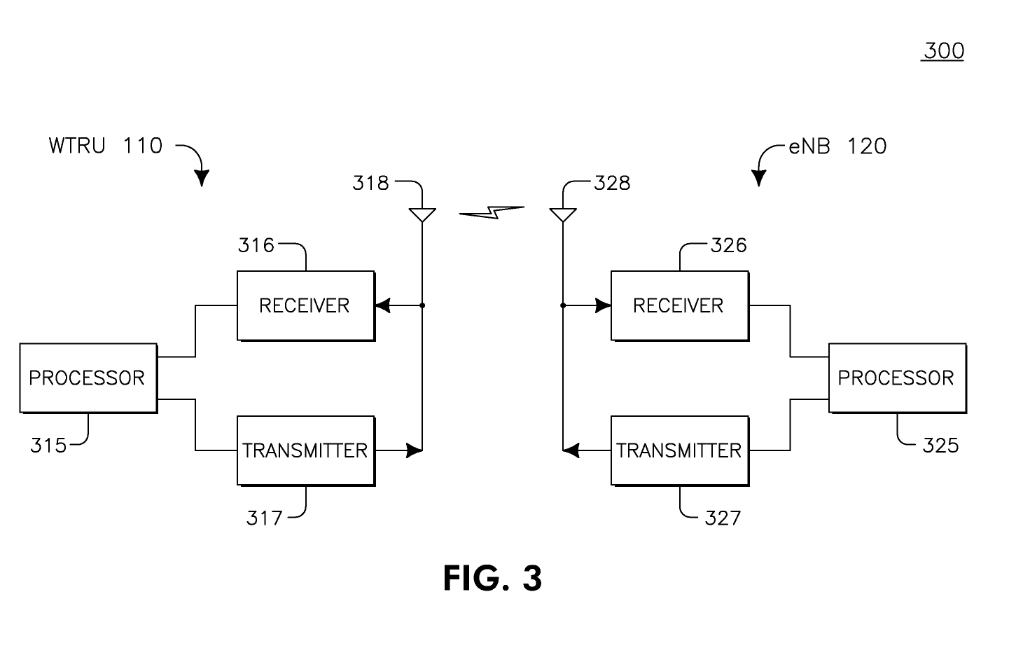

FIG. 3 is a functional block diagram 300 of a WTRU 110 and the eNB 120 of the wireless communication system 200 of FIG. 2. As shown in FIG. 3, the WTRU 110 is in communication with the eNB 120 and both are configured to allocate consecutive Tx sub-frames in a system information transmission window.

In addition to the components that may be found in a typical WTRU, the WTRU 110 includes a processor 315, a receiver 316, a transmitter 317, and an antenna 318. The processor 315 is configured to perform a method for allocating the reception of the consecutive Tx sub-frames in a system information transmission window. The receiver 316 and the transmitter 317 are in communication with the processor 315. The antenna 318 is in communication with both the receiver 316 and the transmitter 317 is configured to facilitate the transmission and reception of wireless data.

In addition to the components that may be found in a typical eNB, the eNB 120 includes a processor 325, a receiver 326, a transmitter 327, and an antenna 328. The processor 325 is configured to perform a method for allocating the transmission of the consecutive Tx sub-frames in a system information transmission window. The receiver 326 and the transmitter 327 are in communication with the processor 325. The antenna 328 is in communication with both the receiver 326 and the transmitter 327 configured to facilitate the transmission and reception of wireless signals.

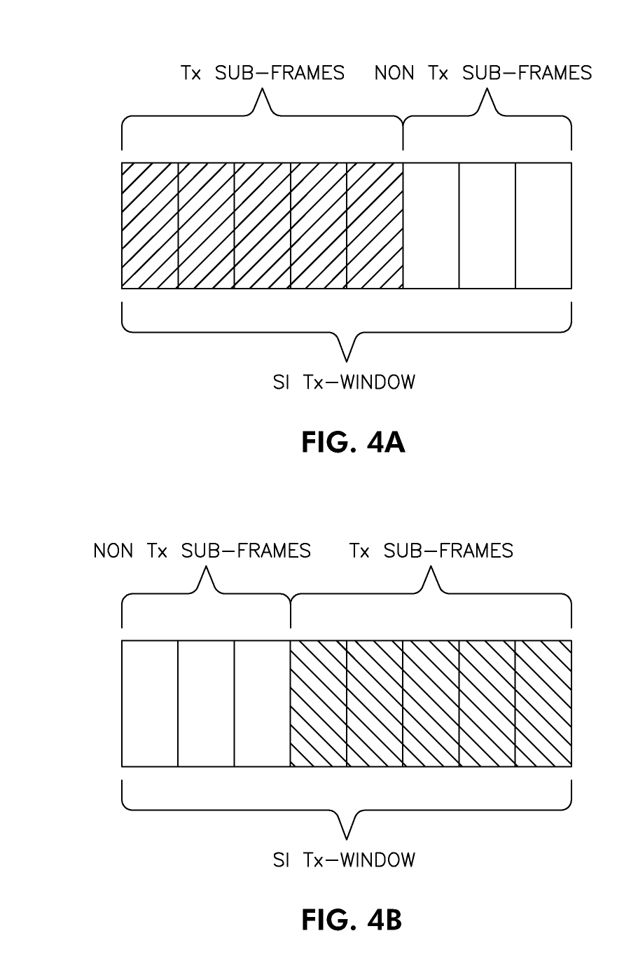

FIGS. 4A and 4B show allocation of the Tx sub-frames for a transmission of system information within a single system information Transmission-window. Referring to the FIG. 4A, the Tx sub-frames are packed at the beginning of the system information Transmission-window, followed by the non Tx sub-frames. FIG. 4B shows the Tx sub-frames that are packed at the end of the system information Transmission-window; while the non Tx sub-frames are packed at the beginning of the Tx-window. Accordingly, the individual non Tx sub-frames may be collected together within a system information Tx-window to provide a significant sleep time to save power. In a case that the Transmission-window of system information or SIB is not interleaved with the SIB-1 transmission (i.e., a non-overlapping Tx-window) in its sub-frame #5, then the system information or the SIB in the Tx-window is transmitted with consecutive Tx sub-frames.

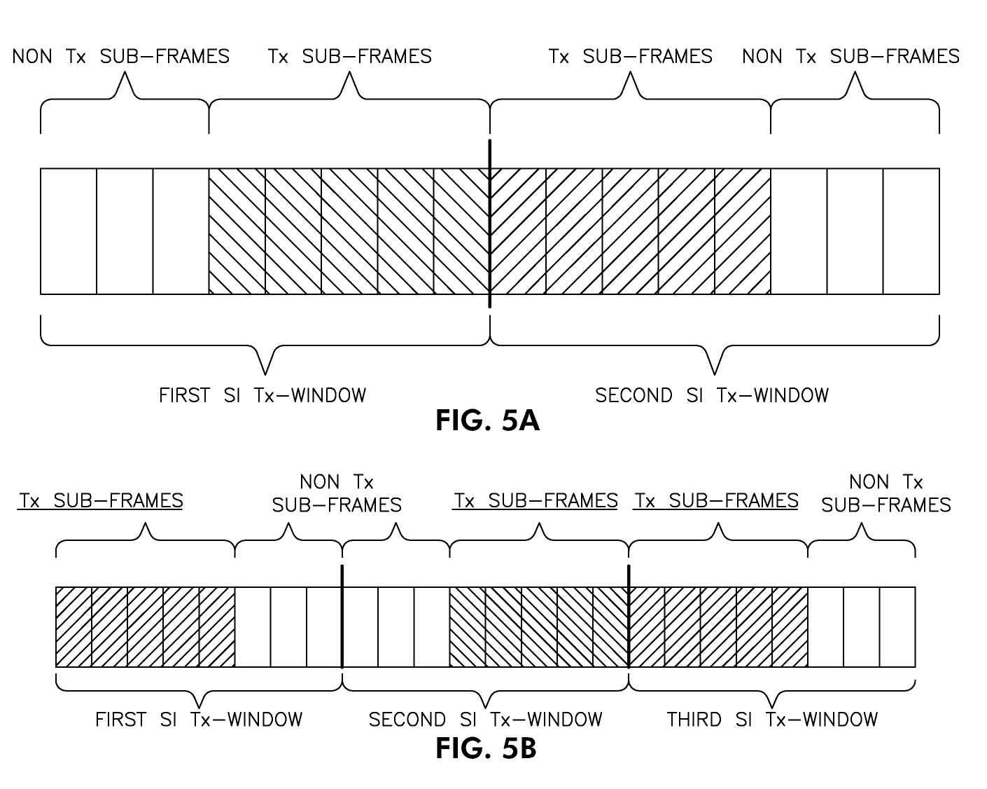

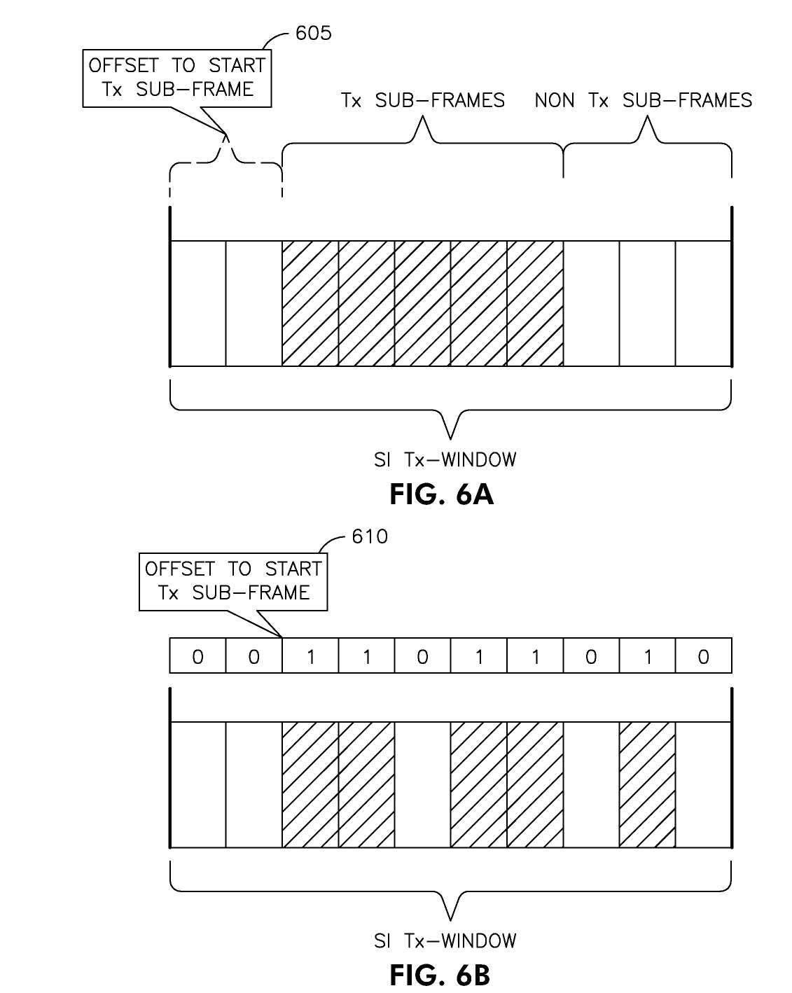

FIGS. 6A and 5B show allocation of the Tx sub-frames and non Tx sub-frames consecutively for a transmission of a system information within an even and odd number of the system information Transmission-window arrangement, respectively. Referring back to FIG. 6A, an even numbered system information Transmission-window arrangement (e.g., two Tx-windows) is shown. Consecutive Tx sub-frames of a first system information Transmission-window and the consecutive Tx sub-frames of a second system information Transmission-window are arranged back-to-back. Within the first system information Transmission-window, the Tx sub-frames are allocated at the end of the window. But, the second subsequent system information Transmission-window, the Tx sub-frames are allocated at the beginning of the window.

Referring to FIG. 5B, an odd numbered system information Transmission-window arrangement (e.g., three) is shown. The consecutive Tx sub-frames of the first system information Transmission-window are arranged in the beginning of the Transmission-window. The consecutive Tx sub-frames of the second system information transmission-window are arranged at the end of the second window so that they are back-to-back with the consecutive Tx sub-frames of the third system information Transmission-window.

Other alternatives of the configuration shown in FIGS. 4A, 4B, 6A, and 5B are also possible, as long as the Tx sub-frames are arranged together back-to-back. The number of Tx sub-frames X of each system information within the system information Transmission-window Y may be different. The value of X may be determined by the standard specification, in a case that the standard transmit bandwidth is used. The value of X may be signaled by the eNB 120 to the WTRUs 110. The value of Y may be signaled by the eNB 120, in a case that the number of sub-frames of the system information Transmission-window is also signaled. On a condition that there are multiple system information Transmission-windows appearing one after another (i.e. staggering system information Tx windows), then further power saving may be achieved.

FIG. 6A shows the position of the Tx sub-frames located in the middle of the system information Transmission-window. Transmission flexibility is achieved by having consecutive Tx sub-frames located in the middle of a system information Transmission-window. FIG. 6A shows an offset of the starting Tx sub-frame 605, which may be pre-defined or may be signaled by the eNB 120.

Alternatively, allocation of the Tx sub-frames may be done intermittently. Because the downlink synchronization channel (DL-SCH) is a shared channel, time critical downlink transmission of other user downlink data services, or command category such as the MBMS service data, may interleave with the system information broadcast data. In other words, the system information subframes for the system information may not be consecutive. In order to receive or decode the system information or SIB from relevant sub-frames, the system information or the SIB reception of the WTRU 110 may know which sub-frame is for the intended system information or SIB and which sub-frame is not for the intended system information or SIB.

In a case that a sub-frame is not used for a relevant system information transmission, or for any other purpose, the eNB 120 may be configured to perform a discontinuous transmission (DTX) of system information on the sub-frame so that the WTRU's 110 system information broadcast reception does not count the data as part of a system information or SIB. In a case that a particular sub-frame is not used by the eNB 120 for a relevant system information transmission but it is used for other purposes, the system information reception of the relevant WTRU 110 system information may be configured to perform a discontinuous reception (DRX) on the non-system information sub-frame, and thereby not accept the non-relevant information of the non-system information subframe for system information or SIB decoding. The WTRU 110 may then count the data on those non-system information sub-frames for other specific data service receptions.

Transmission and reception coordination or synchronization between the eNB 120 and the WTRUs 110 may be achieved statically by the standard specification with respect to each system information. The transmission and reception coordination or synchronization between the eNB 120 and the WTRUs 110 may be signaled based on system information Transmission-window or for groups of SIs or the time period for a predefined number of LTE frames via the system information itself or via the physical downlink control channel (PDCCH) as a system information Transmission-window DRX bitmap.

FIG. 6B shows a system information Transmission-window using a bit-map for the system information Tx sub-frames, illustrating PDCCH DTX or DRX bitmap signaling. The relationship between the system information Tx sub-frames X and the system information Tx-window size Y, where X≦Y, and a bitmap of Y bits may be used to indicate the system information Tx sub-frames and the non system information reception sub-frames in the Tx-window. For example, a bit set to zero may indicate the non system information reception sub-frame and a bit set to one (or vice versa) may indicate the system information Tx sub-frame via the PDCCH signaling or the SIB signaling. An offset of the starting Tx sub-frame 610 may be pre-defined or may be signaled. The bitmap signaling may also be applied to an interleaved Tx-window. It may also be applied to indicate any conditions described above.

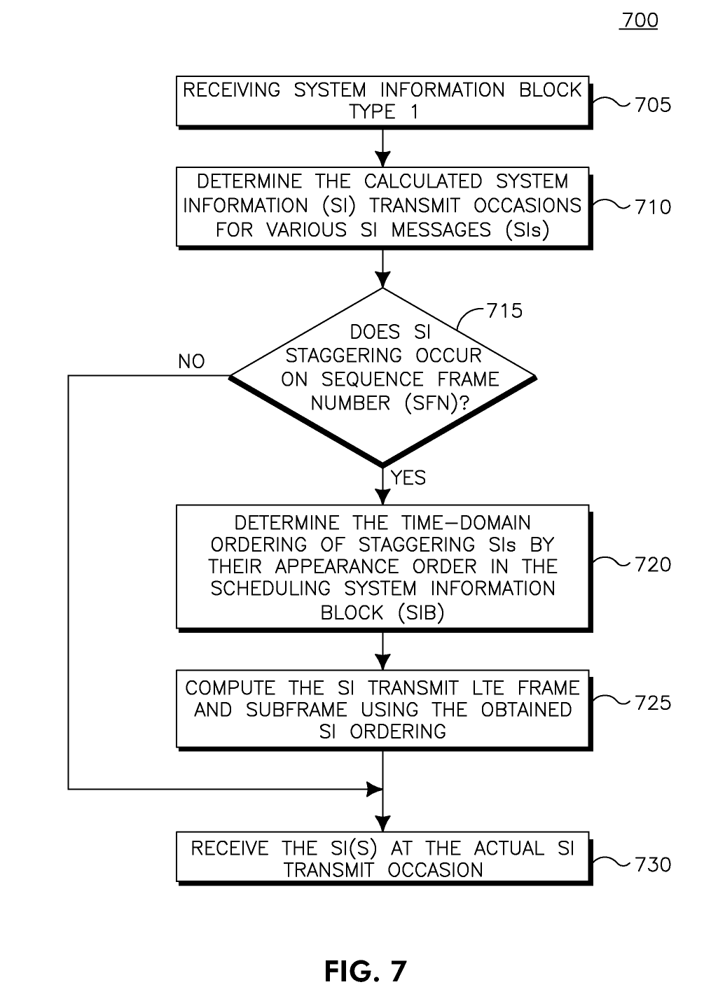

FIG. 7 shows an exemplary only flow diagram 700 of a procedure for receiving the system information and ordering the SIs in the case the system information are staggered. The WTRU 110 is configured to receive the system information block Type 1 (SIB-1) 705 in a known or a predetermined schedule. The WTRU 110 is configured to determine the calculated system information transmit occasions for various SIs 710 from the SIB-1 scheduling information where the system information message combination by SIBs and the periodicities of the system information messages are provided. The transmit occasions for various SIs are determined in order to obtain the frame number of a system information to be broadcast. The appearance of the SIs in the time domain needs to be determined. The LTE frame number, the calculated transmit occasion Z, is determined by using a function of sequence frame number (SFN) mod N 710, where N is the periodicity of the system information. The value of Z may be zero or an offset value.

Multiple staggering SIs situation occurs when the calculated transmit occasion Z is the value of SFN mod N (as mentioned above) and when the calculated transmit occasion Z values for more than one system information are the same 715. When this occurs, the appearance of the SIs in the time domain may be determined by the appearance order of the individual system information message in the scheduling SIB 720. The appearance of the SIs in the time domain may be signaled from the network. The system information transmit LTE frame and subframe are computed using the obtained system information ordering 725. In the case that there is no occurrence of staggering SIs, then the system information messages are received at the actual system information transmit occasion 730. As described, FIG. 7 shows an exemplary procedure 700 for receiving and ordering of system information. It should be noted that other variations of the example procedure 700 are possible.

Alternatively in the multiple staggering SIs situation, the appearance of the SIs in the time domain may be determined by the system information periodicity lengths. In other words, the shorter the periodicity, the earlier the system information is transmitted in the time domain. The SIs with equal periodicity length are determined by the smallest system information block type number in the standard specification. For example, if there are two SIs with the same periodicity length, then the system information message with the smallest system information block type number 3 may be transmitted before the system information message having SIB-4 and/or SIB-5 or so on.

Another alternative is to order the SIs by their SIB numbers. The order may be determined by placing the system information message with the smaller of system information block type number at first. The eNB 120 is configured to broadcast the number of frame of the SIs to the WTRU 110. Alternatively, the order may be determined by the greater system information block type number first. Or, the order may be determined by definitions defined in the standard specification.

Alternatively, in order to solve the broadcast multiple staggering SIs in the same frame situation, part of the staggering SIs to be broadcast are allocated at a predefined frame offset, m, later. The value of m frames may be a signaled parameter from the eNB 120 and it may be used for all of the SIs. The m frames may be used for one or more predefined SFN occasions (i.e., (SFN mod N)=Z). For determining the part of the staggering SIs that needs to be delayed, the following is provided. There are K SIs or K SIBs transmissions staggered. The number of SIs or the SIBs which may be a transmission or a reception delayed or re-scheduled is defined by ┌K/z┐, where ┌ ┐ is a ceiling function and z is the divider such that ┌K/z┐ gives the number of SIs with the transmit/receive m frames offset.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for allocating transmission sub-frames in a system information transmission window, the method comprising:
allocating transmission sub-frames consecutively at beginning of the system information transmission window;
allocating non-transmission sub-frames at end of the system information transmission window; and
transmitting the system information transmission window.

2. The method as in claim 1, further comprising:
allocating the transmission sub-frames within multiple system information transmission windows.

3. The method as in claim 2 wherein the transmission sub-frames and the non-transmission sub-frames are allocated consecutively.

4. The method as in claim 1 wherein on a condition that a transmission sub-frame is not used for system information transmission, then the unused transmission sub-frame is used for a discontinuous transmission (DTX).

5. The method as in claim 4 wherein the unused transmission sub-frame is indicated in an information bitmap from network via a system information block.

6. The method as in claim 1 wherein on a condition that there are multiple system information messages (SIs) transmission window staggered on a single transmit occasion, then an order of SIs is determined by a numerical order of system information block (SIB) numbers.

7. A method of receiving system information, the method comprising:
receiving a first system information block that includes a system information scheduling list and a periodicity for each of a plurality of system information messages and associated system information blocks;
determining whether at least two of the plurality of system information messages have a same calculated transmit occasion; and
in response to a determination that at least two of the plurality of system information blocks have the same calculated transmit occasion, determining an order of actual transmit occasions for the plurality of system information blocks, and receiving the plurality of system information blocks in the determined order of actual transmit occasions.

8. The method of claim 7 wherein the determining an order of actual transmit occasions is based on information signaled by a network.

9. The method of claim 8 wherein the information signaled by the network is contained in the first system information block.

10. The method of claim 7 wherein determining an order of actual transmit occasions is based on the order of entry of the plurality of system information blocks in the first system information block.

11. A wireless transmit receive unit (WTRU) comprising:
a receiver configured to receive a first system information block that includes a system information scheduling list and a periodicity for each of a plurality of system information message and associated system information blocks;
a processor configured to determine whether at least two of the plurality of system information messages have a same calculated transmit occasion, and in response to a determination that at least two of the plurality of system information blocks have the same calculated transmit occasion, determining an order of actual transmit occasions for the plurality of system information blocks; and
the receiver further configured to receive the plurality of system information blocks in the determined order of actual transmit occasions.

12. The WTRU of claim 11 wherein the order of actual transmit occasions is determined based on information signaled by a network.

13. The WTRU of claim 12 wherein the information signaled by the network is contained in the first system information block.

14. The WTRU of claim 11 wherein the order of actual transmit occasions is determined based on the order of entry of the plurality of system information blocks in the first system information block.
